(19) United States
(12) Patent Application Publication
(10) Pub. No.: US 2013/0098723 A1
(43) Pub. Date: Apr. 25, 2013

(54) METHOD AND APPARATUS FOR TRANSPORTING POWER TO ELECTRIC VEHICLE WITH SEGMENTS OF POWER SUPPLY ROAD

(71) Applicants: Dong Ho Cho, Seoul (KR); Nam Pyo Suh, Daejeon (KR); Chang Kyoung Eem, Daejeon (KR); Young Min Kim, Daejeon (KR); Sang Joo Yoo, Daejeon (KR); Hyun Woo Chu, Daejeon (KR); Mi Hyun Park, Daejeon (KR)

(72) Inventors: Dong Ho Cho, Seoul (KR); Nam Pyo Suh, Daejeon (KR); Chang Kyoung Eem, Daejeon (KR); Young Min Kim, Daejeon (KR); Sang Joo Yoo, Daejeon (KR); Hyun Woo Chu, Daejeon (KR); Mi Hyun Park, Daejeon (KR)

(73) Assignee: Korea Advances Institute of Science and Technology, Daejeon (KR)

(21) Appl. No.: 13/496,100

(22) PCT Filed: Oct. 15, 2010
(86) PCT No.: PCT/KR10/07103

§ 371 Date: Dec. 21, 2012

(30) Foreign Application Priority Data
Oct. 15, 2009 (KR) 10-2009-0098406

(51) Int. Cl. B60L 11/18

(52) U.S. Cl. CPC B60L 11/182
USPC 191/10

(57) ABSTRACT

A power transport apparatus for transporting electric power to an electric vehicle on the road is provided. The apparatus includes a plurality of power supply units provided at a road in a longitudinal direction of the road, one or more of the power supply units simultaneously transporting the electric power to the electric vehicle; and a power line supplying the electric power to the respective power supply units.

### TECHNICAL FIELD

The present invention relates to a method and an apparatus for transporting power to an electric vehicle with segments of power supply road and, more particularly to a method and an apparatus for transporting power to an electric vehicle by operating only a segment of power supply road of a power supply equipment including a plurality of power supply segments, where the electric vehicle passes through, in a power transport system transporting power to an electric vehicle by means of electromagnetic induction by a power supply laid under a power supply road.

### BACKGROUND ART

In general, vehicles are driven with fossil fuel. Exhaust gas, drained out of a vehicle after combustion the fossil fuel for driving an engine, causes environmental pollution such as air pollution and global warming. Many researches for vehicles using alternative energy are conducted to solve the environmental pollution. There are alternative energy vehicles such vehicles driven by rechargeable batteries, a fuel cell having hydrogen and oxygen, solar panels, and the like.

However, the electric vehicles have the batteries insufficient to traveling a long distance. Moreover, the electric vehicles with batteries should be stopped while the batteries are recharged. A travelable distance of the electric vehicle with once-recharged capacity of the batteries is limited. To solve this problem, technology of increasing the capacity of batteries and efficiency of a power supply system has been developed, however since the weight of the electric vehicle increases due to the batteries, this power supply system has a low efficiency. Moreover, price of the electric vehicle increases due to the batteries.

As an alternative electric vehicle using batteries, several technologies of transporting power to traveling electric vehicles by electromagnetic induction by a power supply installed under a road have been proposed. (e.g., International Publication No. WO 10/098547). In the proposals, electric power is supplied from the power transport to the electric vehicles during the travel of the electric vehicles. The electric power supplied from the power transport recharges the battery of the electric vehicle and drives the electric vehicle. When the electric power is not supplied from the power supply to the electric vehicle, the electric vehicle may be driven by the recharged batteries.

FIG. 1 shows a power transporting system of a power supply road for an online electric vehicle. As illustrated, electromagnetic field 10 is generated on a power supply road 100 under which power supply to transport electric power to the electric vehicles by means of electromagnetic induction is laid, and a pantograph 210 collecting the electric power supplied from the power supply is installed in the electric vehicles 200. Since power feed lines extends along the power supply road to transport electric power in the existing power supply of electric vehicles, the power supply is operated by electromagnetic field regardless whether electric vehicles travel on the power supply road and costs for managing the power supply road is very expensive. Electromagnetic waves have a bad impact to person and/or general vehicles on the power supply road. Moreover, it is not easy to replace some malfunctioned or broken power supply with a new one.

### DISCLOSURE OF INVENTION

### Technical Problem

It is, therefore, a primary object of the present invention to provide an apparatus for a method of controlling segments of power supply road at a position of a power supply road without an electric vehicle not to generate electromagnetic field for transporting electric power to the electric vehicle to prevent persons and/or general vehicles on the power supply road from being damaged by electromagnetic waves, to reduce electric power consumed by the power supply road, and to improve power transport efficiency.

Another object of the present invention is to provide an apparatus for and a method of allowing to rapidly and easily repair a power supply when replacing a broken or malfunctioned module of the power supply.

### Solution to Problem

In accordance with an aspect of the present invention, there is provided a power transport apparatus for transporting electric power to an electric vehicle on the road, the apparatus including a plurality of power supply units provided at a road in a longitudinal direction of the road, one or more of the power supply units simultaneously transporting the electric power to the electric vehicle; and a power line supplying the electric power to the respective power supply units.

In accordance with another aspect of the present invention, there is provided a power transport apparatus for transporting electric power to an electric vehicle, the apparatus including a plurality of power supply units provided at the road in a longitudinal direction of the road and transporting the electric power to the electric vehicle on the road; a power line supplying the electric power to the respective power supply units; and a segment controller controlling the power supply units in a manner that one or more of the power supply units simultaneously transport an electrical power to the electric vehicle.

In accordance with further aspect of the present invention, there is provided a power transport method of transporting electric power to an electric vehicle using a plurality of power supply units provided at a road, the method including detecting, by a specific power supply unit, the electric vehicle placed on the specific power supply unit; performing power transportation by the specific power supply unit; and cutting off the power transportation when the electric vehicle is not detected.

In accordance with still another aspect of the present invention, there is provided a power transport method of transporting electric power to an electric vehicle using a plurality of power supply units provided at a road, the method including detecting, by a specific power supply unit, the electric vehicle placed on the specific power supply unit; transmitting, by the specific power supply unit, information of the specific power transport to the electric vehicle; receiving, by a segment controller, information on the power supply unit on which the electric vehicle is placed and vehicle information including a speed of the electric vehicle from the electric vehicle; performing, by the segment controller, power transportation of the power supply unit on which the electric vehicle is placed based on the vehicle information; and cutting off, by the segment controller, the power transportation of the power supply unit over which the electric vehicle passed over.

### Advantageous Effects of Invention

According to the present invention, the power supply units, which are the segments of power supply road, on the power supply road through which none of electric vehicles passes are controlled not to generated electromagnetic field used to transport electric power to the electric vehicles so that persons and/or general vehicles on common road may be prevented from damage by electromagnetic waves and that power consumption of the power supply road may be reduced and power transport efficiency may be improved.

Moreover, the power supply may be easily and rapidly replaced with a new one only by the replacement of broken or malfunctioned module of the power supply.

### BRIEF DESCRIPTION OF DRAWINGS

The objects and features of the present invention will become apparent from the following description of embodiments given in conjunction with the accompanying drawings, in which:

FIG. 1 is a view illustrating an existing method of transporting electric power from a power supply road to an online electric vehicle;

FIG. 2 is a perspective view illustrating a segment of power supply road according to one embodiment of the present invention;

FIG. 3 is a perspective view illustrating an arrangement of a plurality of segments of power supply road in a power supply road according to the embodiment of the present invention;

FIG. 4 is a view illustrating an electric vehicle having a pantograph and segments of power supply road laid under the power supply road, according to the embodiment of the present invention;

FIG. 5 is view illustrating power transport performed by segments of power supply road according to the embodiment of the present invention;

FIG. 6 is view illustrating transport of electric power performed by segments of power supply road according to another embodiment of the present invention; and

FIG. 7 is a view illustrating flow of control signals between an online electric vehicle, segments of power supply road, and a segment controller, for the control of the power transportation performed by the segment controller.

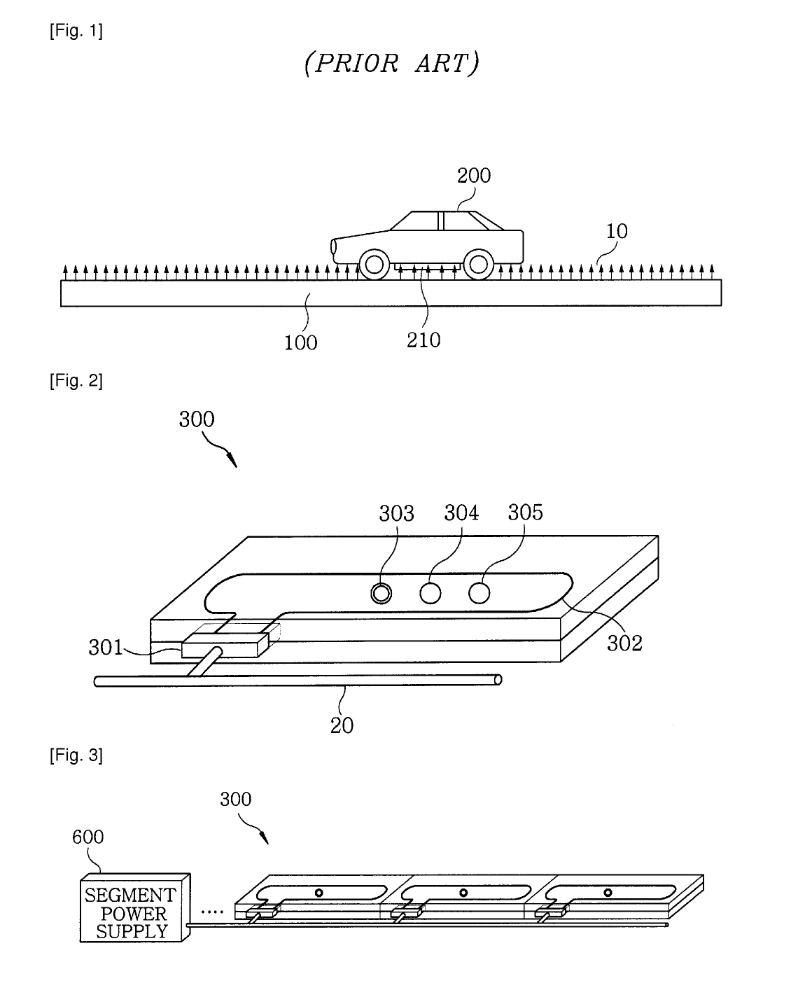

### BEST MODE FOR CARRYING OUT THE INVENTION

Hereinafter, embodiments of the present invention will be described in detail with reference to the accompanying drawings which form a part hereof.

FIG. 2 is a perspective view illustrating a segment of power supply road 300, performing as a power supply unit, according to an embodiment of the present invention.

The segment of power supply road 300 of a power transport laid under a power supply road as a unit module to transport electric power to an electric vehicle includes a power feed line 302 generating electromagnetic field when an electric current flows, a power switch 301 transporting or interrupting electric power from power lines 20 to the power feed line 302 of the segment of power supply road 300, a vehicle detecting sensor 303 detecting an electric vehicle placed on the segment of power supply road 300, and a controller 305 to control the power switch 301 when a vehicle detecting signal is received from the vehicle detecting sensor 303.

The vehicle detecting sensor 303 detects the electric vehicle placed on the segment of power supply road 300 and transmits a vehicle detecting signal to the controller 305 when the electric vehicle is detected.

The vehicle detecting sensor 303 is installed at a position corresponding to respective halves of a length and a width of the segment of power supply road 300.

The controller 305 controls the power switch 301 to flow current through the power feed line 302 when receiving the vehicle detecting signal from the vehicle detecting sensor 303. By doing so, electromagnetic field is generated at the segment of power supply road 300 so that electric power is supplied (transported) to the electric vehicle.

When the controller 305 does not receive the vehicle detecting signal from the vehicle detecting sensor 303, the controller 305 controls the power switch 301 not to flow current through the power feed line 302 in order to stop the electromagnetic field to generate.

The segment of power supply road 300 may further include a communication unit 304 to transmit and receive information of controlling the electric vehicle traveling on the power supply road and the control of transporting electric power thereto. The information transmitted and received by the transceiver 304 includes an identification information ID of the segment of power supply road 300 and ON/OFF status information of the segment of power supply road 300 transmitted to the electric vehicle and information such as a vehicle identification ID and travel speed of the electric vehicle received from the electric vehicle.

FIG. 3 is a view illustrating an arrangement of a plurality of segments of power supply road 300 in a power supply road according to the embodiment of the present invention.

A segment power supply 600 converts three-phase alternating current voltage into direct current voltage using a rectifier and converts the direct current voltage into alternating current voltage using an inverter. When the inverter of the segment power supply 600 is installed near the segment of power supply road, efficiency of the transport of electric power is improved. Considering this, for achieving high efficiency of the power transport, the rectifier converting the alternating current voltage into the direct current voltage is separated from the inverter converting the direct current voltage into the alternating current voltage, and the rectifier and the inverter are installed at different positions while installing the inverter near the segment of power supply road.

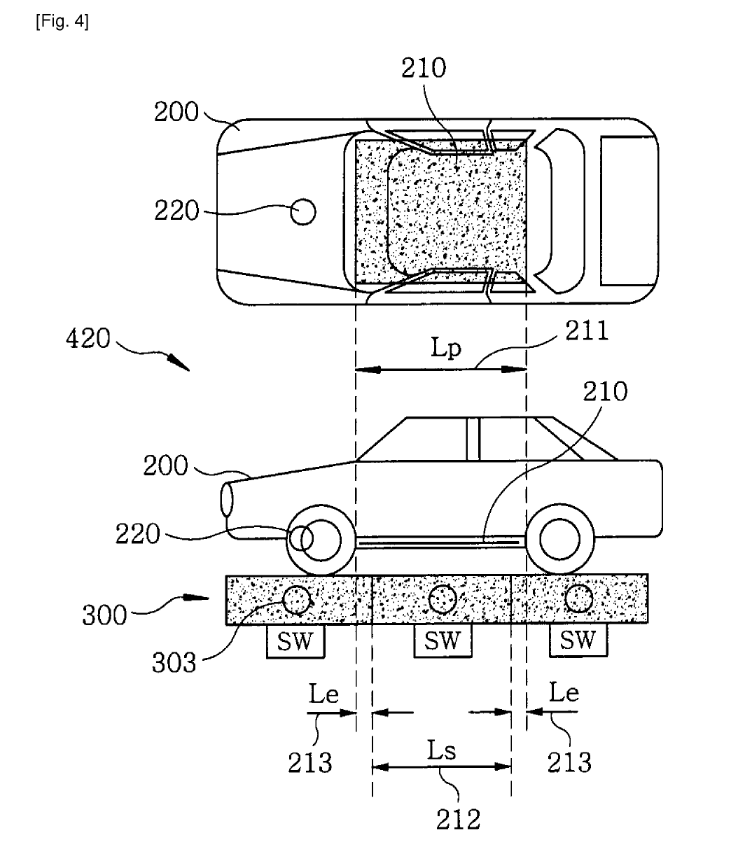

FIG. 4 is a view illustrating an electric vehicle 200 having a pantograph 210 and segments of power supply road 300 laid under the power supply road, according to the embodiment of the present invention.

FIG. 4 shows a plan view 410 and a side view 420 of the electric vehicle 200. The pantograph 210 receives electric power by means of electromagnetic field generated when the power switch 301 of the segment of power supply road 300 that is laid under the power supply road is switched on.

The electric vehicle 200 includes a communication unit 220 transmitting and receiving information about the transport of electric power to and from the communication unit 304 of the segment of power supply road 300. The information transmitted and received by the communication unit 220 of the electric vehicle 200 includes an identification information ID and ON/OFF status information of the segment of power supply road 300, received from the segment of power supply road 300, and an identification information ID and a speed of the electric vehicle transmitted to the segment of power supply road 300. The communication unit 220 of the electric vehicle 200 is installed at a position corresponding to about 1/3 from a front side, a center in the lateral direction, and a lower side of the electric vehicle 200.

The pantograph 210 may be positioned at the lower center of the electric vehicle 200, have a size with the almost same as width of the electric vehicle 200, may be about 1/3 of the electric vehicle 200 long, and have a rectangular shape. The length Lp 211 of the pantograph 210 may be the same as that of the segment of power supply road 300. However, considering a position recognition length Le required for the vehicle detecting sensor 303 of the segment of power supply road 300 to detect that the electric vehicle 200 enters or go away from the segment of power supply road 300, the length Lp 211 of the pantograph 210 may be Lp=Ls+2×Le. The length Lp 211 is shown in FIG. 4.

Considering various types of electric vehicles, the length of the segments of power supply road laid under the power supply road is 1/3 of the length of the shortest electric vehicle.

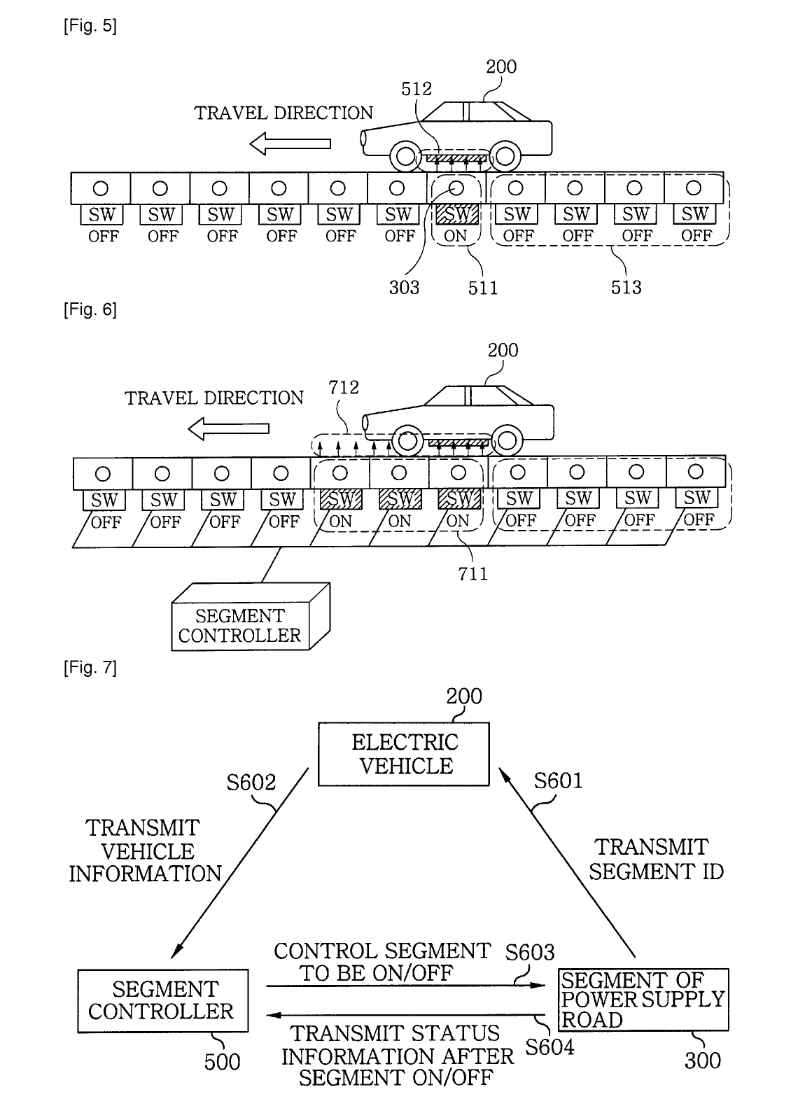

FIG. 5 is view illustrating power transport performed by segments of power supply road according to the embodiment of the present invention.

When a vehicle detecting sensor of a specific segment of power supply road 511 detects an electric vehicle 200, a power switch of the segment of power supply road 511 is switched on to generate electromagnetic field 512 and electric power is transported to the electric vehicle 200. As illustrated in FIG. 5, power switches of segments of power supply road 513 were switched ‘ON’ to transport the electric power to the electric vehicle 200 when the electric vehicle 200 passed over the segments of power supply road 513, and now when the electric vehicle 200 went away from the segments of power supply road 513, the power switches 513 are switched ‘OFF’.

FIGS. 6 and 7 show another embodiment of power transporting method performed the segment of power supply road according to the embodiment of the present invention. Structure of the segment of power supply road, the arrangement of the segments of power supply road under the power supply road, and the pantograph installed in the online electric vehicle are the same as those of the previous embodiment of the present invention.

FIG. 6 is view illustrating transport of electric power by segments of power supply road according to the present embodiment of the present invention.

In this embodiment of the present invention, when speed of the electric vehicle 200 is very fast, the specific number of succeeding segments of power supply road is grouped for the stable power transportation and all segments of power supply road in one group 711 are controlled to be switched on and generate electromagnetic field 712 so that electric power is transported to the electric vehicle 200. The control of the segments of power supply road is performed by a segment controller 500 provided outside the segments of power supply road. Since the segments of power supply road are controlled by the segment controller 500, the controllers 305 of the respective segments of power supply road do not need.

FIG. 7 is a view illustrating flow of control signals between an online electric vehicle 200, segments of power supply road 300, and a segment controller 500, for controlling the power transportation performed by the segment controller.

As illustrated in FIG. 7, the control of power transportation is performed by the segment controller 500. In more detail, when the vehicle detecting sensor 303 detects a vehicle, the communication unit 304 of the segment of power supply road 300 transmits identification information, that is, the ID of the segment of power supply road 300 to the communication unit 220 of the detected electric vehicle 200 entered the power supply road via wireless line (S601). The communication unit 202 of the electric vehicle 200 received the information from the segment of power supply road 300 transmits information on the electric vehicle 200 including the information received from the segment of power supply road 300 to the segment controller 500 (S602). The information on the electric vehicle may include the information on the segment of power supply road 300 at which the electric vehicle is positioned, that is, the ID of the segment of power supply road 300 received from the segment of power supply road 300. The segment controller 500 received the information on the electric vehicle from the electric vehicle 200 transmits a command of ‘switch ON’ to the segment of power supply road 300 promptly (S603), and the segment of power supply road 300 is switched on and transmits the switched-ON status to the segment controller 300 (S604).

The information of the electric vehicle transmitted from the electric vehicle 200 to the segment controller 500 may further include a travel speed of the electric vehicle 200. In this case, the segment controller 500 determines a segment of power supply road to be switched on in addition to the segment of power supply road 300 based on the ID of the segment of power supply road 300 and the speed information of the electric vehicle (S602) and transmits a switching-on command to the determined segment of power supply road (S603).

In this case, the segment controller 500 may control several segments of power supply road as a group to be switched on/off. That is, for the stable power transportation at a high speed of the electric vehicle, the specific number of succeeding segments of power supply road around the segment of power supply road detecting the electric vehicle may be bound into one group to be switched on at the same time. This case is depicted in FIG. 6.

The information of the electric vehicle transmitted from the electric vehicle 200 to the segment controller 500 may further include information such as the ID of the electric vehicle and whether the vehicle needs to be recharged and the information may be used to switch on/off the segments of power supply road. In order to switch the segments of power supply road at optimized condition, positional error or the electric vehicle, power transport time spent in the segment of power supply road, delay time of communication between the electric vehicle and the segments of power supply road, delay time of communication between the electric vehicle and the segment controller, and delay time of communication between the segments of power supply road and the segment controller may be considered in addition to the ID of the electric vehicle.

While the invention has been shown and described with respect to the embodiments, it will be understood by those skilled in the art that various changes and modification may be made without departing from the scope of the invention as defined in the following claims.

1. A power transport apparatus for transporting electric power to an electric vehicle on the road, the apparatus comprising:
a plurality of power supply units provided at a road in a longitudinal direction of the road, one or more of the power supply units simultaneously transporting the electric power to the electric vehicle; and
a power line supplying the electric power to the respective power supply units.

2. The power transport apparatus of claim 1, wherein each of the power supply units includes:
a vehicle detecting sensor detecting whether or not the electric vehicle is placed on the power supply unit;
a power feed line generating electromagnetic field when electric current for transporting the electric power to the electric vehicle flows thereto;
a power switch supplying and cutting off the electric power from the power line to the power feed line; and
a controller controlling the power switch to transport the electric power when the vehicle detecting sensor detects the electric vehicle and to cut off power when the electric vehicle is not detected.

3. A power transport apparatus for transporting electric power to an electric vehicle, the apparatus comprising:
a plurality of power supply units provided at the road in a longitudinal direction of the road and transporting the electric power to the electric vehicle on the road;
a power line supplying the electric power to the respective power supply units; and
a segment controller controlling the power supply units in a manner that one or more of the power supply units simultaneously transport an electrical power to the electric vehicle.

4. The power transport apparatus of claim 3, wherein each of the power supply units includes:
a vehicle detecting sensor detecting whether or not the electric vehicle is placed on the power supply unit;
a communication unit transmitting and receiving information required to control power transportation to and from the electric vehicle traveling on the road and to and from the segment controller;
a power feed line generating electromagnetic field when electric current for transporting the electric power to the electric vehicle flows thereto; and
a power switch supplying and cutting off the electric power from the power line to the power feed line according to the information received by the communication unit.

5. The power transport apparatus of claim 4, wherein the information transmitted from the communication unit to the electric vehicle includes identification information of the power supply unit including the communication unit.

6. The power transport apparatus of claim 4, wherein the information transmitted from the communication unit to the segment controller includes ON/OFF status information of the power switch.

7. A power transport method of transporting electric power to an electric vehicle using a plurality of power supply units provided at a road, the method comprising:
detecting, by a specific power supply unit, the electric vehicle placed on the specific power supply unit;
performing power transportation by the specific power supply unit; and
cutting off the power transportation when the electric vehicle is not detected.

8. A power transport method of transporting electric power to an electric vehicle using a plurality of power supply units provided at a road, the method comprising:
detecting, by a specific power supply unit, the electric vehicle placed on the specific power supply unit;
transmitting, by the specific power supply unit, information of the specific power transport to the electric vehicle;
receiving, by a segment controller, information on the power supply unit on which the electric vehicle is placed and vehicle information including a speed of the electric vehicle from the electric vehicle;
performing, by the segment controller, power transportation of the power supply unit on which the electric vehicle is placed based on the vehicle information; and
cutting off, by the segment controller, the power transportation of the power supply unit over which the electric vehicle passed over.

9. The power transport method of claim 8, wherein in the performance of the power transportation, when the speed of the electric vehicle included in the vehicle information is greater than a preset speed, the segment controller performs power transportation of at least two succeeding power supply units at the same time.

10. The power transport method of claim 8, wherein the vehicle information further includes information on whether the electric vehicle requires power transportation at the present time.
